(19) United States
(12) Patent Application Publication
(10) Pub. No.: US 2008/0031682 A1
(43) Pub. Date: Feb. 7, 2008

(54) Boot seal assembly for a rack and pinion steering gear apparatus

(76) Inventors: Bruce Alan Bosman, Riverview, MI (US); Michael Patrick Schanck, Brownstown, MI (US)

Correspondence Address: AUTOMOTIVE COMPONENTS HOLDINGS LLC;C/O MACMILLAN, SOBANSKI & TODD, LLC, ONE MARITIME PLAZA, FIFTH FLOOR, 720 WATER STREET, TOLEDO, OH, 43604-1853, US

(21) Appl. No.: 11/498,443

(22) Filed: Aug. 3, 2006

(51) Int. Cl. F16J 15/52

(52) U.S. Cl. 403/50

(57) ABSTRACT

A boot seal assembly for a rack and pinion steering gear apparatus having a housing with an inner diameter and a first and second tie rod coupled to a first and second end of the housing, respectively, includes a boot seal and a seal collar secured to the boot seal. The boot seal has a bellows interposed between a housing seal end and a tie rod seal end. The seal collar is secured to the boot seal at the housing seal end. The seal collar further has an outer diameter that sealingly engages the inner diameter of the housing.

### TECHNICAL FIELD

The present invention relates to a steering gear apparatus and, more particularly, to a boot seal assembly for a rack and pinion steering gear apparatus.

### BACKGROUND OF THE INVENTION

A conventional rack and pinion steering gear apparatus for a vehicle has a ball joint connecting a rack to a tie rod and a bearing that supports a rack for movement relative to a housing. A boot seal seals against the housing and the tie rod. If the boot seal does not properly seal against the housing, dirt, water and other contaminants may enter the boot seal. If this occurs, operation of the steering gear may be affected. An inexpensive boot seal that effectively seals against the housing over a long period of time is desirable.

A known boot seal has an internal diameter either equal to or slightly smaller than the outer diameter of the part on which it is to seal. This requires some stretching of the boot seal in order to engage the part. Thereafter, the boot seal is manually secured to the housing by way of a clamp. This clamp requires a controlled torque for securing the boot seal over the housing. If the torque is too high, the clamp could tear the boot. Conversely, if the torque is too low, the seal could become loose and possibly fall off of the housing. In either case, contaminants could enter the housing.

Accordingly, it would be desirable to provide a boot seal for a steering gear housing that overcomes the disadvantages described above.

### SUMMARY OF THE INVENTION

In accordance with the present invention, a boot seal assembly for a rack and pinion steering gear apparatus having a housing with an inner diameter and a first and second tie rod coupled to a first and second end of the housing, respectively, includes a boot seal and a seal collar secured to the boot seal. The boot seal has a bellows interposed between a housing seal end and a tie rod seal end. The seal collar is secured to the boot seal at the housing seal end. The seal collar further has an outer diameter that sealingly engages the inner diameter of the housing.

### BRIEF DESCRIPTION OF THE DRAWINGS

FIG. 1 is a schematic view of a rack and pinion steering gear apparatus having a boot seal assembly constructed in accordance with the present invention;

FIG. 2 is a front view of the boot seal assembly of the present invention;

FIG. 3 is a cross sectional view of the boot seal assembly of the present invention; and

FIG. 4 is a perspective view of the seal collar of the present invention with a locating feature according to one embodiment.

### DESCRIPTION OF THE PREFERRED EMBODIMENT

As representative of the present invention, FIG. 1 illustrates a rack and pinion steering gear apparatus 10 for a vehicle. The apparatus 10 includes a housing 12 and a rack 14, both having a common longitudinal axis 15. The rack 14 is supported by, and is axially movable relative to, the housing 12. The housing 12 and rack 14 have a common first end 16 and a second end 18 opposite the first end 16. The rack 14 is connected to steerable vehicle wheels (not shown) of the vehicle by suitable linkage. The linkage includes a first tie rod 20 and a second tie rod 22 opposite the first tie rod 20.

The first tie rod 20 is connected to the first end 16 by a first ball joint 24 in a known manner. The second tie rod 22 is similarly connected to the second end 18 by a second ball joint 26. Upon axial movement of the rack 14 relative to the housing 12, vehicle wheels (not shown) are turned in a known manner.

An input shaft 28 is mechanically connected with the rack 14 by a pinion 30. The input shaft 28 is connected to a steering wheel 32 of the vehicle. Teeth on the pinion 30 are disposed in meshing engagement with teeth on the rack 14.

The apparatus 10 shown is a manually actuated apparatus. However, it is contemplated that the apparatus 10 could be power assisted and include a motor (not shown), such as an electric motor or a hydraulic motor.

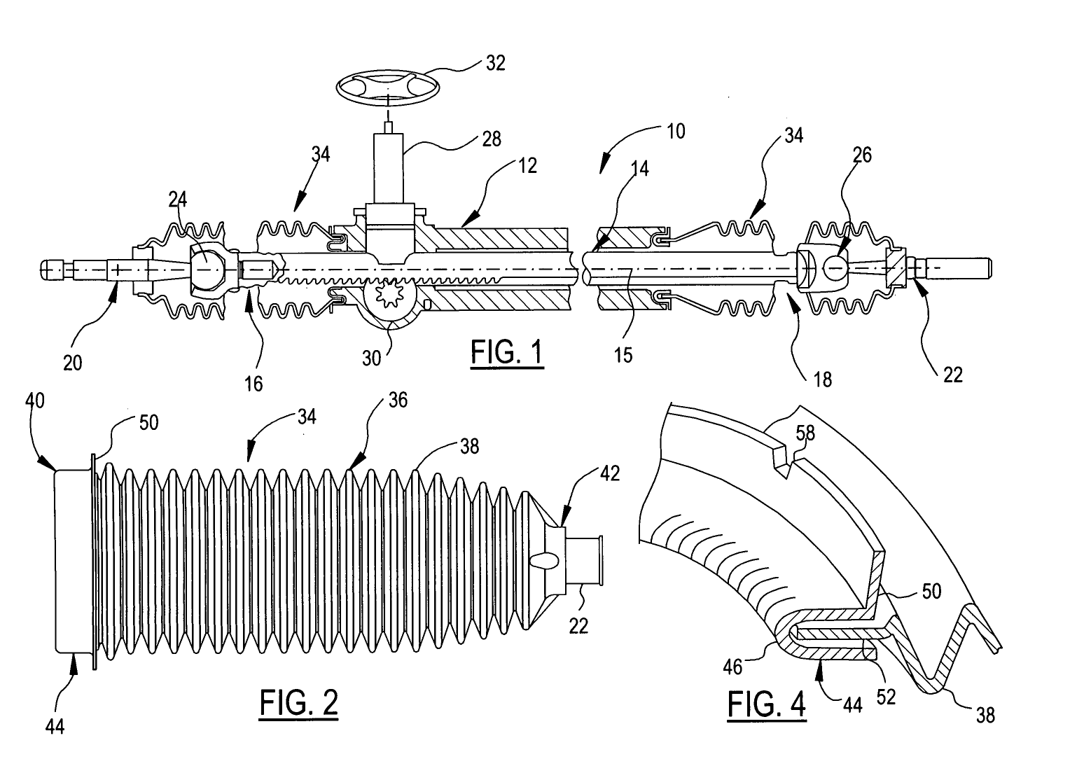

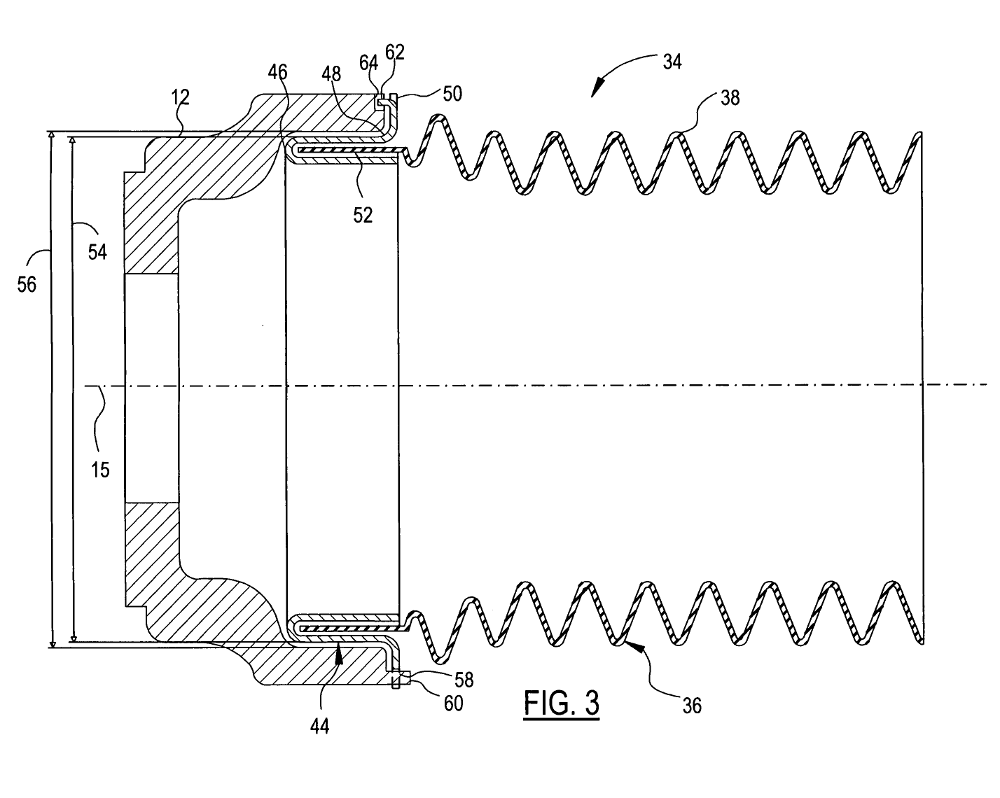

Two boot seal assemblies 34 are typically included with the apparatus 10, one for sealing against one of the tie rods 20 and the first end 16 of the housing 12, and the other for sealing against the other tie rod 22 and the second end 18 of the housing 12. As further illustrated in FIGS. 2 and 3, the boot seal assembly 34 of the present invention is shown in greater detail. The boot seal assembly 34 includes a boot seal 36 having a bellows 38 interposed between a housing seal end 40 and a tie rod seal end 42 at an opposite end of the boot seal 36. The housing seal end 40 seals against the housing 12 of the apparatus 10 and the tie rod seal end 42 seals against the tie rods 20 and 22.

Secured to the boot seal 36 at the housing seal end 40 is a seal collar 44. The seal collar 44 has a first end 46 and a second end 48. In a preferred embodiment, the seal collar 44 further includes a flange 50 extending radially from the second end 48 to aid in inserting the seal collar 44 into the housing 12 and for positioning the seal collar 44 within the housing 12. The seal collar 44 is secured to a flange 52 of the boot seal 36 that extends axially from the bellows 38. The seal collar 44 may be secured to the boot seal 36 in any conventional manner, including, but not limited to, overmolding, crimping, and chemical bonding.

The seal collar 44 has an outer diameter 54 while the housing 12 has an inner diameter 56 wherein the inner diameter 56 is of a value sufficient to allow a press fit with the outer diameter 54 of the seal collar 44. Thus, the seal collar 44 sealingly engages the interior of the housing 12 when inserted therein.

The housing 12 has an inner diameter 56 while the seal collar has an outer diameter 54 of a value sufficient to allow a press fit against the inner diameter 56. Thus, seal collar 44 sealingly engages the housing 12 when inserted therein. If necessary, an adhesive, such as Loctite®, could be used to further secure the fit between the seal collar 44 and the housing 12.

As further shown in FIG. 3, the boot seal assembly 34 may include an alignment feature. The alignment feature may include a notch 58 formed in the flange 50 of the seal collar 44 or a projection or tab 62. In assembly, the assembly equipment (not shown) would orient the boot seal assembly 34 using the alignment feature prior to inserting the boot seal assembly 34 into the housing 12. Alternatively, rather than having the assembly equipment responsible for alignment, a corresponding projection 60 or notch 64 could be formed on the housing 12 to cooperate with the notch 58 or the tab 62, respectively.

The boot seal 36 may be constructed of a suitable material such as a polyester thermoplastic elastomer or even an un-vulcanized rubber with an interspersed polymer. The seal collar 44 may be constructed of a suitable material such as hard plastic or SAE 10/10 steel. To minimize or prevent rusting or to aid in the reduction of assembly or press-in forces, the seal collar 44 may be coated or plated with a material, including, but not limited to, trivalent chrome.

The description of the invention is merely exemplary in nature and, thus, variations that do not depart from the gist of the invention are intended to be within the scope of the invention. Such variations are not to be regarded as a departure from the spirit and scope of the invention.

We claim:

1. A boot seal assembly for a rack and pinion steering gear apparatus having a housing with an inner diameter and a first and second tie rod coupled to a first and second end of the housing, respectively, the boot seal assembly comprising:
a boot seal having a bellows interposed between a housing seal end and a tie rod seal end, the housing seal end for sealingly engaging one of the first and second ends of the housing and the tie rod seal end for sealingly engaging one of the first and second tie rods; and
a seal collar secured to the boot seal at the housing seal end and having an outer diameter, wherein the outer diameter sealingly engages the inner diameter of the housing.

2. The boot seal assembly as recited in claim 1 wherein the seal collar is overmolded onto the boot seal.

3. The boot seal assembly as recited in claim 1 wherein the seal collar is crimped onto the boot seal.

4. The boot seal assembly as recited in claim 1 wherein the seal collar is chemically bonded onto the boot seal.

5. The boot seal assembly as recited in claim 1 wherein the seal collar further comprises a flange extending radially outward therefrom to aid in inserting the seal collar into the housing.

6. The boot seal assembly as recited in claim 1 wherein the seal collar further includes an alignment feature for orientating the seal collar to the housing.

7. The boot seal assembly as recited in claim 6 wherein the alignment feature includes a notch formed in the flange.

8. The boot seal assembly as recited in claim 7 wherein the housing further includes a projection extending therefrom for receipt by the notch formed in the flange in aligning the seal collar to the housing.

9. The boot seal assembly as recited in claim 6 wherein the alignment feature includes a projection extending from the flange.

10. The boot seal assembly as recited in claim 9 wherein the housing includes a notch formed therein for receiving the projection extending from the flange in aligning the seal collar to the housing.

11. The boot seal assembly as recited in claim 1 wherein the seal collar is plated.
